(19) United States
(12) Patent Application Publication
(10) Pub. No.: US 2004/0006524 A1
(43) Pub. Date: Jan. 8, 2004

(54) Quantitative real option intelligent completion valuation system and method

(76) Inventors: Larry Gregg Chorn, Plano, TX (US); Arun Kumar Sharma, Aberdeen (GB); John Han, Spring, TX (US); Shashidhar Rajagopalan, Houston, TX (US); Amit Sharma, Dallas, TX (US)

Correspondence Address: THOMPSON & KNIGHT L.L.P., PATENT PROSECUTION DEPARTMENT, 98 SAN JACINTO BLVD., SUITE 1200, AUSTIN, TX, 78701, US

(21) Appl. No.: 10/190,439

(22) Filed: Jul. 3, 2002

(51) Int. Cl. G06F 17/60

(52) U.S. Cl. 705/36

(57) ABSTRACT

A capital investment that creates operational flexibility using a financial framework and adequately valuing the capital investment using financial mathematics. The capital investment may be an intelligent well completion connecting surface production and injection facilities with an oil and gas reservoir. The intelligent well completion may reduce potential well intervention costs, increase production rate, and increase ultimate recovery. The capital investment described by the financial framework may also affect one or more physical variables that, in turn, affect valuation of a real asset. One or more financial formulas may be applied to the physical variable to adequately value the capital investment.

### BACKGROUND OF THE INVENTION

Any references cited hereafter are incorporated by reference to the maximum extent allowable by law. To the extent a reference may not be fully incorporated herein, it is incorporated by reference for background purposes and indicative of the knowledge of one of ordinary skill in the art.

### FIELD OF THE INVENTION

The present invention relates generally to the field of quantitative analysis of real options.

### DESCRIPTION OF RELATED ART

Nearly all Real Option applications build on the mathematical model developed for financial options by Fischer Black and Myron Scholes as modified by Robert Merton. See Black, F. and Scholes, M., “The Pricing of Options and Corporate Liabilities,” Journal of Political Economy, Volume 81, pp. 637-654, May-June 1973 and Merton, R. C., “Theory of Rational Option Pricing,” Bell Journal of Economics and Management Science, Volume 4, pp. 141-183, Spring 1973. Myron Scholes and Robert Merton were awarded the 1997 Nobel Prize in Economics for their financial options valuation model. Fischer Black, who died in 1995, was also mentioned in the award citation. One solution to the model, from Ross, S. A, et. al., Corporate Finance, 1999, Irwin/Mcgraw Hill, Singapore, pp. 560-561, is:

V=S*N(d₁)−X*e^{-rt}*N(d₂)

$$\begin{matrix}{d}_{1} = \frac{ln ( S / X ) + ( r + \frac{1}{2} * {σ}^{2} ) * {t}_{option}}{\sqrt{{σ}^{2} * {t}_{option}}} \\ {d}_{2} = {d}_{1} - \sqrt{{σ}^{2} *} {t}_{option}\end{matrix}$$

Where:

V=Value of the option

S=Current stock price

X=Exercise price of the call

σ²=Variance (per year) of the continuous return on the stock

tₒₚₜᵢₒₙ=Time in years to expiration date

r =Continuous risk free rate of return (annualized)

N(d) =Probability that a standard, normally distributed, random variable will be less than or equal to d.

Stewart Myers of M.I.T. made the observation that the Black-Scholes model could be used to value investment opportunities in real markets. Timothy Luehrman publishes an excellent description of the adaptation of financial option mathematics to Real Option theory in the Harvard Business Review (1998). See Luehrman, T. A., “Investment Opportunities as Real Options: Getting Started on the Numbers,” Harvard Business Review, July-August 1998, reprint number 98404.

The value of keeping one's options open is best understood in investment-intensive industries, i.e. Oil and Gas, where licensing, exploration, appraisal and development processes fall naturally into stages, each pursued or abandoned according to the results of a previous stage of development. Thus, today's efforts in the use of Real Options in Oil and Gas have focused on portfolio optimization and R&D planning as described by Larry Chorn (1997, 1998, 2000, 2001). See Chorn, L. G. and Carr, P. P., “The Value of Purchasing Information to Reduce Risk in Capital Investment Projects,” paper 37948 presented at the 1997 SPE hydrocarbon Economics and Evaluation Symposium, Dallas, Tex., March 16-18 and Real Options and Business Strategy, Chapter 12, Risk Books 1999; Chorn, L. G. and Croft, M., “Resolving Reservoir Uncertainty to Create Value,” paper 49094 presented at the 1998 Annual Technical Conference and Exhibition held in New Orleans, La., Sep. 27-30, 1998 and Journal of Petroleum Technology, August 2000, pp. 54-59; and Donlon, B. and Chorn, L., “A Practical Architecture for Real Options Analysis,” paper 71406 presented at the 2001 SPE Annual Technical Conference held in New Orleans, Sep. 30 -Oct. 3, 2001.

The Black-Scholes equation is the simplest analytic solution to the options model. It is one of several solution approaches, including but not limited to binomial trees, decision trees, dynamic programming, finite difference techniques and Monte Carlo simulation. Real Options SmartWell® valuation can be implemented through any of these approaches.

### BRIEF SUMMARY OF THE INVENTION

Embodiments of the present invention comprise describing a capital investment that creates operational flexibility using a financial framework and adequately valuing the capital investment using financial mathematics. The capital investment may be an intelligent well completion connecting surface production and injection facilities with an oil and gas reservoir. The intelligent well completion may reduce potential well intervention costs, increase production rate, and increase ultimate recovery. The capital investment described by the financial framework may also affect one or more physical variables that, in turn, affect valuation of a real asset. One or more financial formulas may be applied to the physical variable to adequately value the capital investment.

### BRIEF DESCRIPTION OF THE DRAWINGS

The following drawings form part of the present specification and are included to further demonstrate certain aspects of the present invention. The figures are not necessarily drawn to scale. The invention may be better understood by reference to one or more of these drawings in combination with the detailed description of specific embodiments presented herein.

FIG. 1 shows reduced uncertainty in the expected value of S, in accordance with an embodiment of the present invention.

FIG. 2 shows an increased expected value for S, in accordance with an embodiment of the present invention.

FIG. 3 shows typical production over time with reduced intervention costs, in accordance with an embodiment of the present invention.

FIG. 4 shows typical production over time contrasted with intelligent completion to accelerate production, in accordance with an embodiment of the present invention.

FIG. 5 shows typical production over time contrasted with intelligent completion to increase production life, in accordance with an embodiment of the present invention.

FIG. 6 shows typical production over time contrasted with intelligent completion to accelerate production and increase production life, in accordance with an embodiment of the present invention.

FIG. 7 shows an example of flexibility provided by relaxation of certain production profile constraints, in accordance with an embodiment of the present invention.

FIG. 8 shows nonstandard production profile construction, in accordance with an embodiment of the present invention.

FIG. 9 shows the operations of a SmartWell® preferred embodiment via a flowchart.

### DETAILED DESCRIPTION OF PREFERRED EMBODIMENTS

A patent application (Chorn, L., “Method and System for Conducting a Valuation in a Real Option Investment,” U.S. patent application Ser. No. 09/615,982, Jul. 14, 2000) has been filed by one of the Joint Inventors and Real Options Software, Inc. to protect their proprietary solution framework for Real Options analysis. The solution framework, embodied in Real Options Software, Inc.'s commercial software product named FlexAble, leads the user through the selection of appropriate option mathematics, required data gathering, and valuation calculations. Real Options SmartWell® valuation utilizes the solution framework embodied in Real Options Software, Inc.'s commercial software product named FlexAble to create a unique software application product.

Embodiments of the present invention apply financial option mathematics and concepts to valuation of capital investments creating operational flexibility. In the preferred embodiment, the capital investment is an intelligent well completion in the oil and gas industry. Specifically, the preferred embodiment is directed to implementation of a SmartWell® completion for connecting surface production and injection facilities with an oil and gas reservoir. But the scope of the present invention, as claimed, is not limited to a SmartWell® implementation or even to implementations in the oil and gas industry.

Options mathematics are used extensively in financial portfolio analysis but have not been used to represent capital investments generally. For example, Real Options mathematics have not been used in the oil and gas industry to make operational field development decisions. Appropriate conceptual problem designs for the oil and gas industry and mathematics to solve those problems using Real Options mathematics have not been developed. Thus, deterministic cash flow methods for valuing projects using net present value analysis fail to adequately value future flexibility to better manage potentially catastrophic future events both expected and unexpected. Intelligent well completion projects are better able to capitalize on potential future revenue generating events that will occur at uncertain dates. The value-generating functionality of intelligent well completion in the oil and gas industry derives from the ability to monitor and control fluid production and injection by zone in real time. Unlike conventional methods, the procedures are not expensive or time consuming given an intelligent well completion. Intelligent completions also minimize risk by better leveraging technology-advanced well bores such as multilateral and extended reach horizontals to increase total recovery through time thereby optimizing flow regulation to shut off or choke back water or gas after breakthrough. Some intelligent well systems can measure flow rates and water cut, commingle production from separate reservoirs, optimize artificial lift efficiency and control production from or injection into zones with varying permeability. Other intelligent well functionalities include the ability to control flow from or into separate reservoirs, control cross flow, conduct interventionless completion deployment and perform pressure build up tests while maintaining production from other zones. Many other similar benefits are achieved by using intelligent well completions. For measurement purposes, the benefits of intelligent well technology can be represented in a project's cash flow and production profile. Costs are effected by increasing operational efficiencies by reduced interventions, reduced water production, etc., and differing capital expenses. Intelligent completions can increase expected value of a project over time and decrease the volatility or variance of the project's expected production profile. For an example of the former, see [PCT application 2001 IP 0005453 U1 “Smartdump” filed Oct. 10, 2001 by WellDynamics, Inc.].

Deterministic valuation methods especially overlook reductions in variance. Discounted cash flow valuation methods are most appropriate in problems in which the decision maker is not able to make adjustments in real time. Examples of such problems are conventional completions, which require major separate capital investments to reconfigure. By contrast intelligent completions give operators additional information in real time and the ability to act on that information in real time. Production options can be taken advantage of as they occur whether or not those options were foreseen.

Redefining Black-Scholes to meet the requirements of the intelligent completions model; the critical variables for a Real Options SmartWell® valuation are as follows:

S=(Underlying value) PV of expected incremental net revenues from an intelligent completion application. S is a function of product reliability.

C=(Acquisition price) PV of capital costs to acquire revenues in S.

σ²=(Volatility) The amount of uncertainty in S resolved within time period t. Primary focus should be on changes in production profile due to intelligent completion application and associated functionality.

tₒₚₜᵢₒₙ=(Option lifetime) Time to first intelligent completion benefit.

r=(Discount rate) Operator WACC or corporate hurdle rate.

The most complex variables to quantify in the SmartWell® Options model are S (as influenced by production), σ² and tₒₚₜᵢₒₙ.

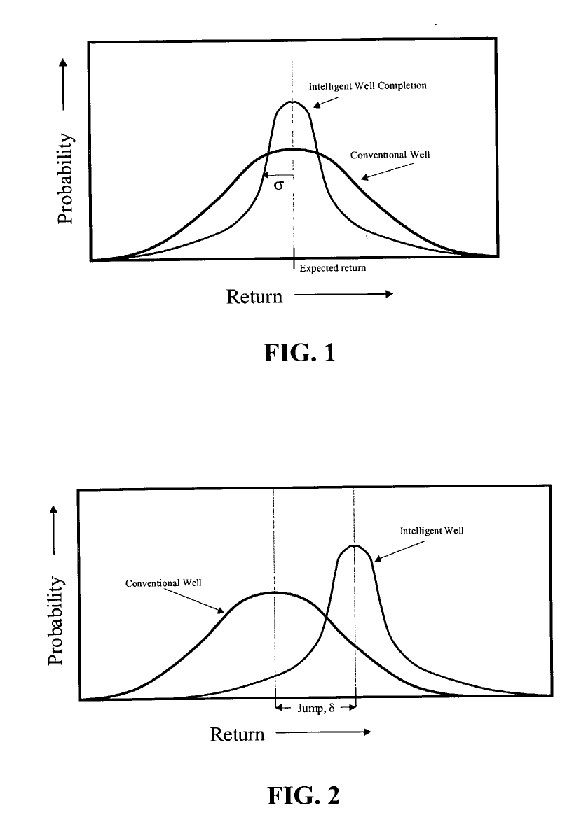

FIG. 1 illustrates a reduction in return variability gained through an intelligent well completion as compared to a conventional well completion. FIG. 2 shows an increase in expected return by an intelligent well completion as compared to a conventional well completion and that increase and expected return would come about either through taking advantage of unforeseen opportunities or mitigation of unforeseen losses. The valuation of the uncertainty resolution illustrated in FIG. 2 requires application of mathematics developed by Merton to handle jump discontinuities in production available to the operator through actuating intelligent completion hardware. See Merton, R. C., “Option Pricing When Underlying Stock Returns Are Discontinuous,” Journal of Financial Economics, 3 (January-March, 1976), pp. 125-144.

The option value equation becomes:

$$V = {\sum }_{i = 0}^{∞} \frac{{{ⅇ}^{- λ t} ( λ t )}^{i}}{i !} {V}_{i} ( S , X , t , \sqrt{{σ}^{2} + {δ}^{2} ( i / t )} , r ) ;$$

where λ is the expected number of jumps in S per year. For applications to the Real Options SmartWell® valuation model, λ equals one.

As illustrations, four production problem types will be described in greater detail. The first type is where the intelligent well completion reduces intervention cost. The second problem type is where the intelligent well completion accelerates production. The third problem type is where the intelligent well completion increases production life thereby increasing recovery, and the fourth problem type is where the intelligent well completion both accelerates production and increases recovery by extending production life.

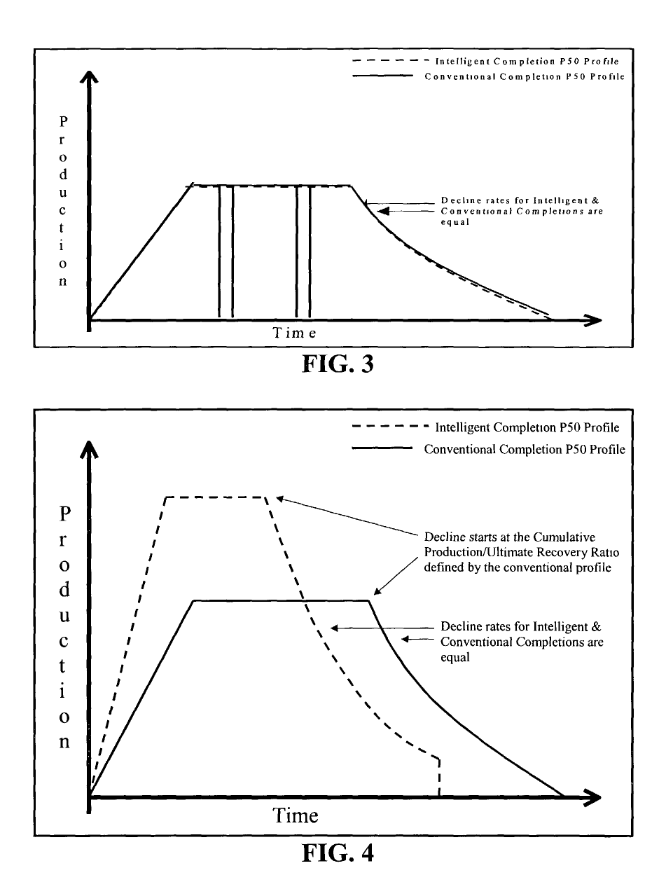

FIG. 3 illustrates reduced intervention costs stemming from implementation of an intelligent well completion. This problem type is especially relevant to sub-sea developments where rig availability and high rig rental rates can result in significant production down-time and intervention costs. The mathematics describing the value of reduced intervention costs resulting from an intelligent well completion can be represented as follows:

$$\begin{matrix}V = {S}_{typeA} * N ( {d}_{1} ) \\ {S}_{typeA} = {\sum }_{τ = 0}^{∞} Re ( τ ) * {P}_{i} ( τ ) * [ {X}_{i} + {q}_{i} ( τ ) * Pr ( τ ) - RT ( τ ) ] * {ⅇ}^{- r τ} \\ {d}_{1} = \frac{ln ( {S}_{typeA} / C ) + ( r + \frac{1}{2} * {σ}^{2} ) * {t}_{option}}{\sqrt{{σ}^{2} * {t}_{option}}}\end{matrix}$$

where:

S_{typeA}=PV(expected revenue savings)

C=cost of intelligent completion implementation

Pᵢ(τ)=probability of an intervention at or before t

i=number of interventions required

τ=time of intervention occurrance

tₒₚₜᵢₒₙ=time until first anticipated intervention of a conventional well is avoided

Xᵢ=cost of intervention

qᵢ=cummulative production lost during intervention

Pr(τ)=sales price per unit of production

RT(τ)=royalties and taxes

Re(τ)=reliability of intelligent completion hardware as a function of time

Embodiments of the present invention directed at the second problem type, i.e., accelerated production resulting from an implementation of an intelligent well completion, are illustrated in FIG. 4. An example of this problem type is the use of an intelligent completion to realize commingled production from multiple zones that could not be previously commingled via conventional completion technology. In this example, the analyst would enter the expected production profile (P50) based on conventional completion technology and the expected peak production rate (P50) for an intelligent completion implementation. Assumptions in this problem type are that (1) the intelligent completion peak production rate exceeds the conventional rate, (2) the intelligent completion ultimate recovery is equivalent to the conventional ultimate recovery, (3) the intelligent completion production profile starts to decline at a cumulative production/ultimate recoverables ratio entered by the analyst, and (4) the decline rate of the intelligent completion production profile is equal to the decline rate of the conventional production profile. The mathematics describing the value of accelerating production resulting from an intelligent completion implementation can be represented as follows:

$$V = {S}_{typeB} * N ( {d}_{1} )$$

$${S}_{typeB} = {\int }_{0}^{{t}_{p}} [ q ( t ) * ( Pr ( t ) - {c}_{v} - RT ( t ) ) * {P}_{{q}_{p}} - {c}_{f} ] * {ⅇ}^{- r t} ⅆ t + {\int }_{{t}_{p}}^{{t}_{d}} [ ( Re ( t ) * {q}_{pSW} ( t ) - {q}_{pCC} ( t ) ) * ( Pr ( t ) - {c}_{v} - RT ( t ) ) * {P}_{{q}_{p}} - {c}_{f} ] * {ⅇ}^{- r t} ⅆ t + {\int }_{{t}_{d}}^{{t}_{a}} [ {α}_{cc} ( t ) * ( Re ( t ) * {q}_{qSW} ( t ) - {q}_{pCC} ( t ) ) * ( Pr ( t ) - {c}_{v} - RT ( t ) ) * {P}_{{q}_{p}} - {c}_{f} ] * {ⅇ}^{- r t} ⅆ t$$

where:

q(t)=instantaneous hydrocarbon production rate from start-up to plateau rate

q_{pCC}(t)=plateau production rate for conventional completion

q_{pSW}(t)=plateau production rate for intelligent completion

tₚ=time to reach plateau production rate

t_{d}=time when production rate begins to decline from plateau

tₐ=time when field is abandoned due to low rate

P_{q}_{ₚ}=Probability distribution for qₚ

Re(t)=reliability of intelligent completion hardware as a function of time

cᵥ=variable operating costs

c_{f}=fixed operating costs

RT(t)=royalties and taxes

α_{cc}=decline rate for field with convention completions

Q_{cc}=ultimate recovery for a conventional completion

Q_{SW}=ultimate recovery for an intelligent completion

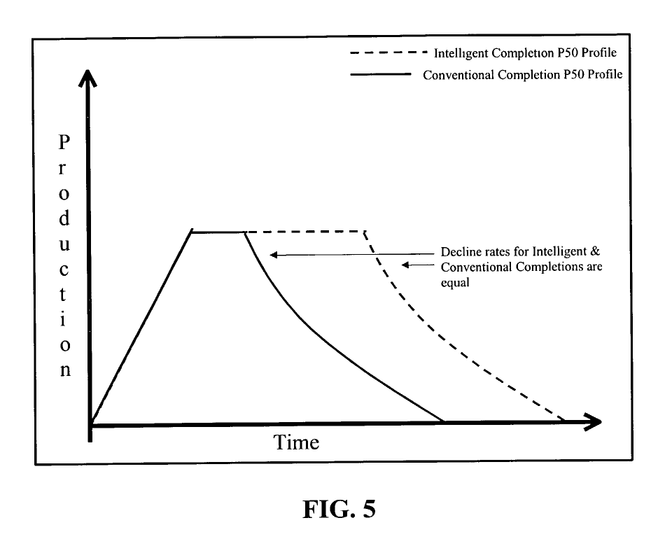

The third problem type depicted in FIG. 5 is that of increased production life stemming from an intelligent completion also described as increased ultimate intelligent completion recovery. One example of this is using intelligent completion to access more zones from single well bores than are accessible through conventional completion techniques but being facility constrained. In this problem type, the increased recoverables would not come from improved reservoir management. The analyst would enter the expected production profile (P50) based on conventional completion technology and the expected recoverable volume (P50) for an intelligent completion implementation. Assumptions for this problem type would be that (1) the intelligent completion peak production rate is equivalent to the conventional peak rate, (2) the intelligent completion ultimate recovery exceeds the conventional recovery, (3) the intelligent completion production profile starts to decline at a cumulative/ultimate recoverable ratio entered by the analyst, and (4) the intelligent completion decline rate entered by the analyst. The mathematics describing the value of increased ultimate recovery resulting from an intelligent completion implementation can be represented as follows:

$$V = {S}_{typeC} * N ( {d}_{1} )$$

$${S}_{typeC} = {\int }_{0}^{{t}_{p}} [ q ( t ) * ( Pr ( t ) - {c}_{v} - RT ( t ) ) * {P}_{{q}_{p}} - {c}_{f} ] * {ⅇ}^{- r t} ⅆ t + {\int }_{{t}_{p}}^{{t}_{d} ( Q ) {P}_{Q}} Re ( t ) * [ {q}_{p} ( t ) * ( Pr ( t ) - {c}_{v} - RT ( t ) ) * {P}_{{q}_{p}} - {c}_{f} ] * {ⅇ}^{- r t} ⅆ t + {\int }_{{t}_{d} ( Q ) {P}_{Q}}^{{t}_{a}} ( Re ( t ) * {α}_{SW} ( t ) - {α}_{cc} ( t ) ) * {q}_{p} ( Pr ( t ) - {c}_{v} - RT ( t ) ) * {P}_{{q}_{p}} - {c}_{f} ] * {ⅇ}^{- r t} ⅆ t$$

$${d}_{1} = \frac{ln ( {S}_{typeC} / C ) + ( r + \frac{1}{2} * {σ}^{2} ) * {t}_{option}}{\sqrt{{σ}^{2} * {t}_{option}}}$$

with the constraint that:

qₚ(conventional completion)=qₚ(intelligent completion)

where:

Q=ultimate recovery

P_{Q}=Probability distribution for Q

α_{cc}(t)=decline rate for conventional completion as a function of time

α_{SW}(t)=decline rate for intelligent completion as a function of time

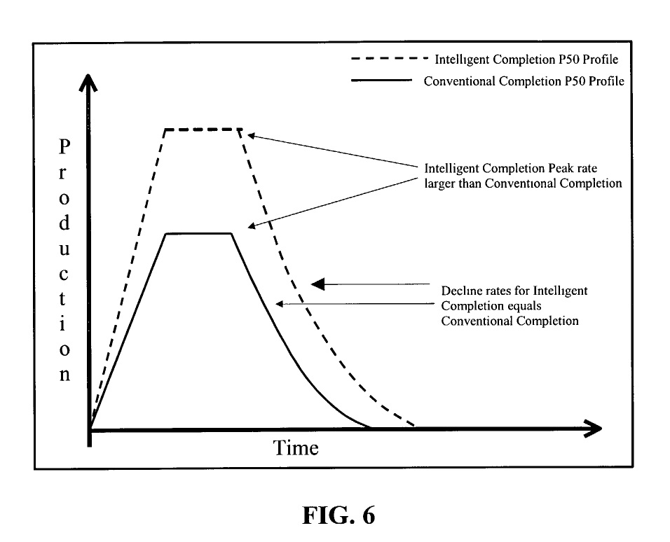

The fourth problem type described in detail is illustrated in FIG. 6. This problem type quantifies the value associated with production rate increases coupled with increased ultimate recovery resulting from optimized reservoir management. An example of this problem type is the use of an intelligent completion to accelerate hydrocarbon production by commingling zones while also improving sweep efficiencies by better control of gas or water productions and injections.

The conventional and SmartWell® profiles can be defined using one of the following three alternatives:

Alternative 1: The user inputs a P50 conventional profile and provides the P10 and P90 conventional peak rates and/or recovery values as well as the P10, P50, and P90 SmartWell® peak rate and/or recovery values. The intermediate profiles (i.e., P30) will be calculated and then used to calculate option values.

Alternative 2: The user enters a P50 conventional and a P50 SmartWell® production profile. The user also provides P10 and P90 conventional peak rates and/or recovery values as well as P10 and P90 SmartWell® peak rate and/or recovery values. The remaining profiles are generated and then used to calculate the options values. This alternative allows the user to build profiles constrained by the P50 profile shape.

Alternative 3: The user will enter the P10, P50, P90 conventional and P10, P50, P90 SmartWell® profiles. The remaining profiles will then be generated using the variance or the distance between the P10 and P50 profiles. The user can enter profiles that are shaped differently from each other, in other words, non-standard profiles. This alternative allows the user to build profiles with no constraints.

Assumptions of this problem type would include (1) the intelligent completion peak production rate is normally larger than the conventional peak rate and the increase could require an additional facility's rework and costs, (2) the intelligent completion ultimate recovery exceeds the conventional ultimate recovery, and (3) the intelligent completion production profile shape can be different from the conventional production profile. The mathematics describing the value of increasing ultimate recovery and peak production rate resulting from an intelligent completion implementation can be represented as follows.

$$V = {S}_{typeD} * N ( {d}_{1} )$$

$${S}_{typeD} = {\int }_{0}^{{t}_{p}} Re ( t ) * [ q ( t ) * ( Pr ( t ) - {c}_{v} - RT ( t ) ) * {F}_{{q}_{p} , Q} - {c}_{f} ] * {ⅇ}^{- rt} ⅆ t + {\int }_{{t}_{p}}^{{t}_{d} ( {q}_{p} , Q ) {F}_{{q}_{p} , Q}} [ ( Re ( t ) * {q}_{pSW} ( t ) - {q}_{pCC} ( t ) ) * ( Pr ( t ) - {c}_{v} - RT ( t ) ) * {F}_{{q}_{p} , Q} - {c}_{f} ] * {ⅇ}^{- rt} ⅆ t + {\int }_{{t}_{d} ( {q}_{p} , Q ) {F}_{{q}_{p} , Q}}^{{t}_{a}} [ ( Re ( t ) * {α}_{SW} ( t ) - {α}_{cc} ( t ) ) * {q}_{p} ( Pr ( t ) - {c}_{v} - RT ( t ) ) * {F}_{{q}_{p} , Q} - {c}_{f} ] * {ⅇ}^{- rt} ⅆ t$$

where:

tₐ and t_{d} are functions of qₚ and Q

F_{q}_{ₚ}^{,Q}=Bivariate probability distribution for qₚ, plateau production rate, and Q, ultimate reco

Reliability of an intelligent well completion can be represented by adjustment of the production profile, which in turn adjusts project return. The model can assume that the profile reverts to a conventional completion if the intelligent completion hardware fails. A separate stochastic representation of the specific intelligent well completion equipment used in the implementation is generated and used to adjust the production profile associated with an intelligent completion.

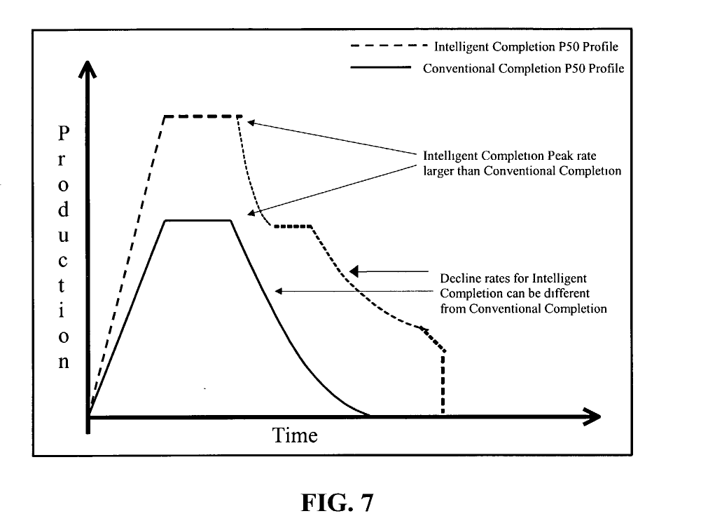

FIG. 7 shows an example of flexibility provided by relaxation of certain production profile constraints.

These profiles can be generated from external sources such as numerical simulation or real data sets. The mathematics describing this problem type would be similar to those describing the fourth problem type with the inclusion of non-standard profile shapes. For example, the mathematics would take advantage of the creation of a model to represent the timing t_{d} of the decline onset as a function of reservoir properties and intelligent well configuration. The decline onset for an intelligent well implementation would be delayed from that of a conventional completion implementation. The mathematics of that constraint requires:

1. Computing the incremental contribution of the intelligent well completion relative to that of a conventional completion; and

2. Modifying the problem type to accommodate non-standard (not straight lines) annual production estimates for the “ramp-up” and “plateau” portions of the production profile. The modification requires monitoring the intelligent well profile relative to the conventional profile for each year of operation and constraining the Intelligent completion production profile to a fixed total recovery from the reservoir.

Implementing non-standard production profiles in the valuation process can be accomplished with the following mathematics:

$$V = {S}_{incremental} * N ( {d}_{1} )$$

$${S}_{incremental} = {\int }_{0}^{t ( for {q}_{Sw} \geq {q}_{cc} )} \{ [ {q}_{cc} ( t ) + [ {P}_{{q}_{SW}} * {q}_{sw} ( t ) - {q}_{cc} ( t ) ] * Re ( t ) ] * ( Pr ( t ) - {c}_{v} - RT ( t ) ) - {c}_{f} \} * {ⅇ}^{- rt} ⅆ t + {\int }_{t ( for {q}_{Sw} \geq {q}_{cc} )}^{∞} \{ {P}_{{q}_{SW}} * {q}_{sw} ( t ) * ( Pr ( t ) - {c}_{v} - RT ( t ) ) - {c}_{f} \} * {ⅇ}^{- rt} ⅆ t - {\int }_{0}^{∞} \{ {q}_{cc} ( t ) * ( Pr ( t ) - {c}_{v} - RT ( t ) ) - {c}_{f} \} * {ⅇ}^{- rt} ⅆ t$$

$${d}_{1} = \frac{ln ( {S}_{incremenntal} / C ) + ( r + \frac{1}{2} * {σ}^{2} ) * {t}_{option}}{\sqrt{{σ}^{2} * {t}_{option}}}$$

with all variables defined as before.

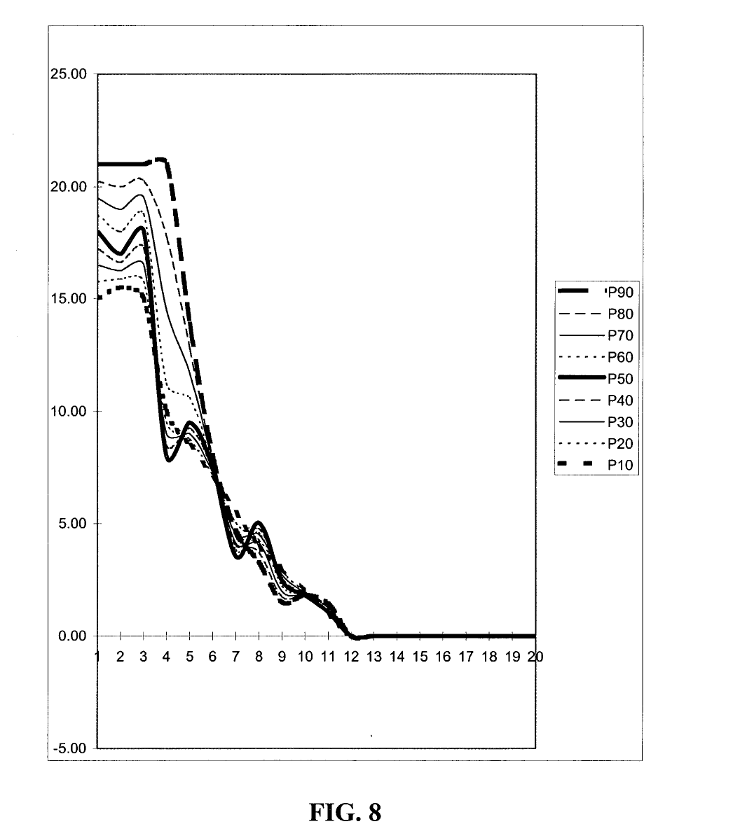

Turning to FIG. 8 an example of profile construction required by the flexible problem model enhancement for nonstandard production profiles is illustrated. Comparative conventional completion and intelligent completion production profiles are provided by the output of a simulation of differential reservoir performance. Stochastic simulations can provide P10, P50, and P90 profile estimates for conventional and intelligent completions thereby relaxing the requirement that all profiles have the same shape. For example, the production profile shapes for P10 and P90 may differ from the production profile shape of P50. Also, intervening profiles, for example in this case P80, P70 etc., may be interpolated. In FIG. 8, the P90, P50, and P10 profiles are indicated with bold lines: the P90 profile being a dashed line, the P50 profile being a solid line, and the P10 profile being a dotted line. In this embodiment the P80, P70, and P60 are interpolated between the P50 and P90 lines. Likewise, the P40, P30, and P20 are interpolated between the P50 and P10 lines. In one sense implementation of embodiments of the present invention characterize an intelligent completion as an option offering the right but not the obligation to make an investment and receive an incremental value. Valuation of the project would typically vary stochastically, with benefits of the intelligent completion being reflected in its positive effect on revenue and ability to reduce uncertainty in a future series of cashflows.

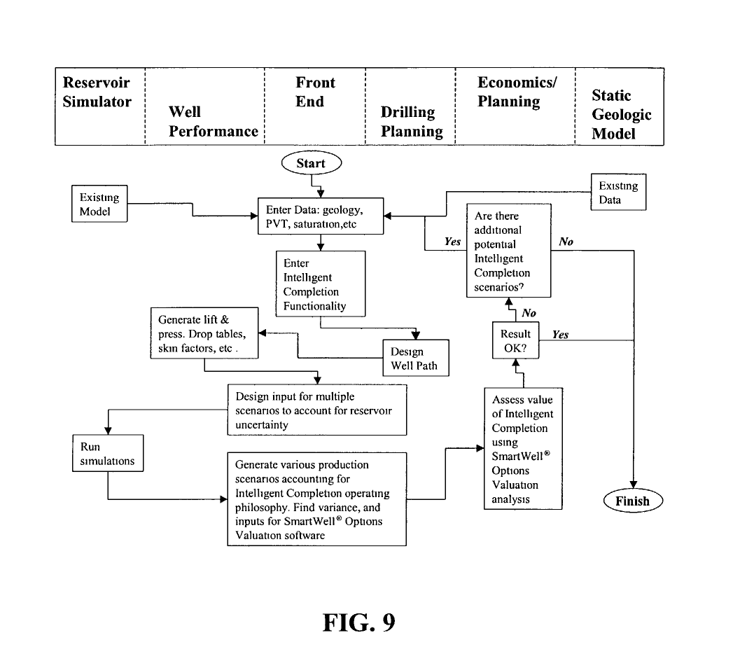

FIG. 9 illustrates an overall intelligent completion screening process according to an embodiment of the present invention. Reservoir simulation and well simulation techniques generate a comparative model. Scenarios are developed to generate variances in reservoir performance affecting the timing of events requiring intervention of reservoir monitoring or management. Results of these interventions on production performance are expressed in terms of S,^{σ}_{²}, and tₒₚₜᵢₒₙ. The results are used as input in the Real Options SmartWell® valuation tool embodied in the form of a software application.

The intelligent completion screening process shown in FIG. 9 includes six categories of activity: reservoir simulator, well performance, front end drilling, planning, economics planning, and static geologic model. The flow chart begins at the front end with the entry of data pertaining to geology, pressure-volume-temperature (PVT), saturation, etc. An existing model is input from the reservoir simulator and existing data is input from the static geologic model. Next, intelligent completion functionality is entered from the front end. Then, a well path is designed as a drilling planning activity. That is followed by the well performance activity of generating lift and pressure drop tables, skin factors, etc. Then as a front end activity, input from multiple scenarios to account for reservoir uncertainty is designed. Then the reservoir simulator generates production performance realizations. Afterward in the front end various production scenarios are generated accounting for intelligent completion operating philosophy, variances computed, and inputs for SmartWell® Options Valuation software are ascertained. This step is followed by the economics planning step of assessing the value of intelligent completion using SmartWell® Options Valuation analysis. If the result is positive then the process completes. If the result is not positive and if there are additional potential intelligent completion scenarios, they are entered and the process repeats. In addition to the various embodiments discussed above, general assumptions can be made to generate S,^{σ}_{²}, and tₒₚₜᵢₒₙ from general scenario planning exercises. In this case the tool would be useful for qualitative comparison purposes.

As apparent from the above, this application presents new Real Options mathematics for valuing operational flexibility. The mathematics is loosely based on a financial “asset or nothing” option.

In this application, “oil and gas reservoir” means oil reservoir, gas reservoir, or oil and gas reservoir.

Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provision of 35 U.S.C. § 112, ¶ 6.

It should be apparent from the foregoing that an invention having significant advantages has been provided. While the invention is shown in only a few of its forms, it is not just limited to those forms but is susceptible to various changes and modifications without departing from the spirit thereof.

What is claimed is:

1. A method of valuation comprising:
designating a capital investment that creates operational flexibility;
describing the capital investment using a financial framework;
valuing the capital investment using financial mathematics; and
wherein the operational flexibility resulting from the capital investment is adequately valued.

2. The method of claim 1, wherein the financial mathematics comprises discounted cash flow analysis structured in a flexibility option framework.

3. The method of claim 1, wherein the capital investment comprises implementing an intelligent well completion for connecting surface production and injection facilities with an oil and gas reservoir.

4. The method of claim 3, wherein the implementing the intelligent well completion reduces potential well intervention costs.

5. The method of claim 4, wherein the valuing the capital investment using financial mathematics comprises solving the following set of equations for V:
$$V = {S}_{typeA} * N ( {d}_{1} )$$
$${S}_{typeA} = {\sum }_{r = 0}^{∞} Re ( τ ) * {P}_{i} ( τ ) * [ {X}_{i} + {q}_{i} ( τ ) * Pr ( τ ) - RT ( τ ) ] * {ⅇ}^{- r τ}$$
$${d}_{1} = \frac{ln ( {S}_{typeA} / C ) + ( r + \frac{1}{2} * {σ}^{2} ) * {t}_{option}}{\sqrt{{σ}^{2} * {t}_{option}}}$$
where:
s_{typeA}=PV(expected revenue savings)
C=cost of intelligent completion implementation
Pᵢ(τ)=probability of an intervention at or before t
i=number of interventions required
τ=time of intervention occurrance
tₒₚₜᵢₒₙ=time until first anticipated intervention of a conventional well is avoided
Xᵢ=cost of intervention
qᵢ=cummulative production lost during intervention
Pr(τ)=sales price per unit of production
RT(τ)=royalties and taxes
Re(τ)=reliability of intelligent completion hardware as a function of time

6. The method of claim 3, wherein the implementing the intelligent well completion increases production rate.

7. The method of claim 6, wherein the valuing the capital investment using financial mathematics comprises solving the following set of equations for V:
$$V = {S}_{typeB} * N ( {d}_{1} )$$
$${S}_{typeB} = {\int }_{0}^{{t}_{p}} [ q ( t ) * ( Pr ( t ) - {c}_{v} - RT ( t ) ) * {P}_{{q}_{p}} - {c}_{f} ] * {ⅇ}^{- rt} ⅆ t + {\int }_{{t}_{p}}^{{t}_{d}} [ ( Re ( t ) * {q}_{pSW} ( t ) - {q}_{pCC} ( t ) ) * ( Pr ( t ) - {c}_{v} - RT ( t ) ) * {P}_{{q}_{p}} - {c}_{f} ] * {ⅇ}^{- rt} ⅆ t + {\int }_{{t}_{d}}^{{t}_{a}} [ {α}_{cc} ( t ) * ( Re ( t ) * {q}_{pSW} ( t ) - {q}_{pCC} ( t ) ) * ( Pr ( t ) - {c}_{v} - RT ( t ) ) * {P}_{{q}_{p}} - {c}_{f} ] * {ⅇ}^{- rt} ⅆ t$$
where:
q(t)=instantaneous hydrocarbon production rate from start-up to plateau rate
q_{pCC}(t)=plateau production rate for conventional completion
q_{pSW}(t)=plateau production rate for intelligent completion
tₚ=time to reach plateau production rate
t_{d}=time when production rate begins to decline from plateau
tₐ=time when field is abandoned due to low rate
P_{q}_{ₚ}=Probability distribution for qₚ
Re(t)=reliability of intelligent completion hardware as a function of time
cᵥ=variable operating costs
c_{f}=fixed operating costs
RT(t)=royalties and taxes
α_{cc}=decline rate for field with convention completions
Q_{cc}=ultimate recovery for a conventional completion
Q_{SW}=ultimate recovery for an intelligent completion

8. The method of claim 3, wherein the implementing the intelligent well completion increases ultimate recovery.

9. The method of claim 8, wherein the valuing the capital investment using financial mathematics comprises solving the following set of equations for V:
$$V = {S}_{typeC} * N ( {d}_{1} )$$
$${S}_{typeC} = {\int }_{0}^{{t}_{p}} [ q ( t ) * ( Pr ( t ) - {c}_{v} - RT ( t ) ) * {P}_{{q}_{p}} - {c}_{f} ] * {ⅇ}^{- rt} ⅆ t + {\int }_{{t}_{d}}^{{t}_{d} ( Q ) {P}_{Q}} Re ( t ) * [ {q}_{p} ( t ) * ( Pr ( t ) - {c}_{v} - RT ( t ) ) * {P}_{{q}_{p}} - {c}_{f} ] * {ⅇ}^{- rt} ⅆ t + {\int }_{{t}_{d} ( Q ) {P}_{Q}}^{{t}_{a}} [ ( Re ( t ) * {α}_{SW} ( t ) - {α}_{cc} ( t ) ) * {q}_{p} ( Pr ( t ) - {c}_{v} - RT ( t ) ) * {P}_{{q}_{p}} - {c}_{f} ] * {ⅇ}^{- rt} ⅆ t \\ {d}_{1} = \frac{ln ( {S}_{typeC} / C ) + ( r + \frac{1}{2} * {σ}^{2} ) * {t}_{option}}{\sqrt{{σ}^{2} * {t}_{option}}}$$
with the constraint that:
qₚ(conventional completion)=qₚ(intelligent completion)
where:
Q=ultimate recovery
P_{Q}=Probability distribution for Q
α_{cc}(t)=decline rate for conventional completion as a function of time
α_{SW}(t)=decline rate for intelligent completion as a function of time

10. The method of claim 3, wherein the implementing the intelligent well completion increases production rate and increases ultimate recovery.

11. The method of claim 10, wherein the valuing the capital investment using financial mathematics comprises solving the following set of equations for V:
$$V = {S}_{typeD} * N ( {d}_{1} )$$
$${S}_{typeD} = {\int }_{0}^{p} Re ( t ) * [ q ( t ) * ( Pr ( t ) - {c}_{v} - RT ( t ) ) * {F}_{{q}_{p} , Q} - {c}_{f} ] * {ⅇ}^{- rt} ⅆ t + {\int }_{{t}_{p}}^{{t}_{d} ( {q}_{p} , Q ) {F}_{{q}_{p} , Q}} [ ( Re ( t ) * {q}_{pSW} ( t ) - {q}_{pCC} ( t ) ) * ( Pr ( t ) - {c}_{v} - RT ( t ) ) * {F}_{{q}_{p} , Q} - {c}_{f} ] * {ⅇ}^{- rt} ⅆ t + {\int }_{{t}_{d} ( {q}_{p} , Q ) {F}_{{q}_{p} , Q}}^{{t}_{a}} [ ( Re ( t ) * {α}_{SW} ( t ) - {α}_{cc} ( t ) ) * {q}_{p} ( Pr ( t ) - {c}_{v} - RT ( t ) ) * {F}_{{q}_{p} , Q} - {c}_{f} ] * {ⅇ}^{- rt} ⅆ t$$
where:
tₐ and t_{d} are functions of qₚ and Q
F_{q}_{ₚ}_{,Q}=Bivariate probability distribution for qₚ, plateau production rate, and Q, ultimate recovery

12. The method of claim 1, wherein the valuing the capital investment using financial mathematics comprises mapping capital investment variables to the financial framework.

13. A method of valuation comprising:
designating a capital investment that creates operational flexibility and affects at least one physical variable that affects valuation of a real asset;
describing the capital investment and the physical variable using a financial framework; and
valuing the capital investment using financial mathematics comprising applying at least one financial mathematics formula to the physical variable.

14. The method of claim 13, wherein the real asset is an oil and gas reservoir.

15. The method of claim 14, wherein the valuing the capital investment using financial mathematics comprising applying at least one financial mathematics formula to the physical variable comprises valuing a reduction of potential well intervention costs attributable to the capital investment.

16. The method of claim 14, wherein the valuing the capital investment using financial mathematics comprising applying at least one financial mathematics formula to the physical variable comprises valuing an increase of production rate attributable to the capital investment.

17. The method of claim 14, wherein the valuing the capital investment using financial mathematics comprising applying at least one financial mathematics formula to the physical variable comprises valuing an increase of ultimate recovery attributable to the capital investment.

18. The method of claim 14, wherein the valuing the capital investment using financial mathematics comprising applying at least one financial mathematics formula to the physical variable comprises valuing an increase of production rate and an increase of ultimate recovery attributable to the capital investment.
